(19) United States
(12) Patent Application Publication
(10) Pub. No.: US 2007/0289634 A1
(43) Pub. Date: Dec. 20, 2007

(54) Method and Apparatus for the Sealing of Valves

(76) Inventor: Robert Peter Enston, Colwyn Bay (GB)

Correspondence Address: BAY AREA INTELLECTUAL PROPERTY GROUP, LLC, P.O. Box 210459, San Francisco, CA, 94121-0459, US

(21) Appl. No.: 11/750,299

(22) Filed: May 17, 2007

Related U.S. Application Data
(63) Continuation-in-part of application No. PCT/GB04/04822, filed on Nov. 17, 2004.

(51) Int. Cl. F16K 51/00; F16K 3/36

(52) U.S. Cl. 137/246.12

(57) ABSTRACT

A method is provided for the injecting fluid into a valve by, for example, introducing the fluid into the valve under pressure through a first, inlet port in the valve housing, providing a second, outlet port in the valve housing for ingress of material displaced from the interior of the valve; and monitoring the pressure of the fluid introduced into the valve through a third monitoring port in the valve housing. By monitoring the pressure of the fluid introduced into the valve it is possible to prevent the applied pressure from exceeding the safe working pressure of the valve.

### CROSS-REFERENCE TO RELATED APPLICATIONS

The present continuation-in-part patent application claims priority benefit under 35 U.S.C. 120 and 365(c) of the PCT international patent application designating the United States number PCT/GB2004/0004822 filed Nov. 17, 2004.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to the sealing of valves and in particular, but not exclusively, to the sealing of valves used to control the flow of natural gas.

### BACKGROUND OF THE INVENTION

It is important that flow control valves control the flow of fluid without allowing any of the fluid to leak through the valve. At the same time, it is important that the valve be kept operational at all times to allow it to perform its flow control function.

For many flow control valves, particularly those used as gas flow control valves, these functions are achieved by the provision of an elastomeric seal ring located between the moving valve closure member of the valve and the static portions of the valve. The seal ring helps to provide an effective seal to prevent the escape of fluid through the valve.

It is known that such seals degrade with time. Normally the seals become degraded which reduces the effectiveness of the gas seal.

In some valves the seal rings' effectiveness is augmented by a sealant applied when the valve is assembled. In some cases, degradation of the sealant occurs to such an extent that the valve closure member cannot be moved. This occurs particularly if the valve is controlling the flow of natural gas because the natural gas tends to “strip out” the base oil of the sealant. A stuck valve obviously has adverse implications from a safety point of view but, just as importantly, it means that in order to fix the fault (either by fixing the valve itself or by replacing it with a new valve) it is necessary to dismantle the valve, which involves isolating the valve from the fluid flow which is time-consuming, expensive and which normally involves cutting off the fluid flow for the duration of the remedial works.

In view of the foregoing, there is a need to provide a method and apparatus for replacing and/or injecting sealant into a valve in situ without the need to isolate the fluid flow in valves whose original design could not facilitate the replenishment or introduction of sealants inherent to the design of the valve.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a perspective view of a shear seal gate valve, for illustration purposes;

FIG. 2 is a front view, in cross-section, of the shear seal gate control valve of FIG. 1;

FIG. 3 is a cross-sectional side view of the gate valve illustrated in FIG. 2;

FIG. 4 is a side view of an apparatus for injecting sealant in accordance with the present invention;

FIG. 5 is a plan view of the apparatus of FIG. 4; and

FIGS. 6a to 6d are side and plan views of four spindles used with the apparatus of FIG. 4.

Unless otherwise indicated illustrations in the figures are not necessarily drawn to scale.

### SUMMARY OF THE INVENTION

To achieve the forgoing and other objects and in accordance with the purpose of the invention, a variety of techniques for the sealing of valves are described.

In one embodiment of the present invention, a method is provided for the injecting fluid into a valve by introducing the fluid into the valve under pressure through a first, inlet port in the valve housing, providing a second, outlet port in the valve housing for ingress of material displaced from the interior of the valve; and monitoring the pressure of the fluid introduced into the valve through a third monitoring port in the valve housing.

In other embodiments, a method of treating a valve includes the steps of introducing a sealant into the valve under pressure through a first, inlet port in the valve housing, providing a second, outlet port in the valve housing for egress of material displaced from the interior of the valve, introducing a sealant/lubricant into the valve under pressure through the first, inlet port in the valve housing; and monitoring the pressure of the fluids introduced into the valve through a third, monitoring port in the valve housing.

An apparatus embodiment of the present invention is provided for forming an aperture in a valve housing, which includes a base member having sealing means for sealingly engaging and enclosing a portion of the surface of the valve housing, an aperture in the base member for passage of a tool into contact with a portion of the base member enclosed by the sealing means and a tall holder having a plurality of tool-receiving apertures, the tool holder being movable relative to the base member to a plurality of operative positions in each of which one of the tool-receiving apertures is aligned with the aperture in the base member.

In other embodiments, steps and means for achieving the foregoing functions are provided.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

In accordance with a first aspect of the present invention, a method of injecting fluid into a valve comprises the steps of:

introducing the fluid into the valve under pressure through a first, inlet port in the valve housing;

providing a second, outlet port in the valve housing for egress of material displaced from the interior of the valve; and

monitoring the pressure of the fluid introduced into the valve through a third, monitoring port in the valve housing.

By ensuring that the pressure within the valve is monitored as the fluid is introduced under pressure, it can be ensured that the maximum safe internal working pressure of the valve is not exceeded.

In one embodiment, one or more of the ports is formed in the valve housing. This would be appropriate if, for example, ports did not already exist in the valve housing.

Preferably, the monitoring port is located between the inlet port and the outlet port.

The fluid introduced into the valve may comprise a sealant and/or may comprise a lubricant.

The fluid introduced into the valve may comprise a solvent and/or a flushing fluid.

In accordance with a second aspect of the present invention, a method of treating a valve comprises the steps of:

introducing a sealant into the valve under pressure through a first, inlet port in the valve housing;

providing a second, outlet port in the valve housing for egress of material displaced from the interior of the valve;

introducing a sealant/lubricant into the valve under pressure through the first, inlet port in the valve housing; and

monitoring the pressure of the fluids introduced into the valve through a third, monitoring port in the valve housing.

In accordance with a third aspect of the present invention, an apparatus for forming an aperture in a valve housing comprising a base member having sealing means for sealingly engaging and enclosing a portion of the surface of the valve housing, an aperture in the base member for passage of a tool into contact with a portion of the base member enclosed by the sealing means and a tool holder having a plurality of tool-receiving apertures, the tool holder being movable relative to the base member to a plurality of operative positions in each of which one of the tool-receiving apertures is aligned with the aperture in the base member.

By providing a tool holder having a plurality of tool-receiving apertures, the base member may be located on the valve housing and tools located in each of the tool-receiving apertures can in turn to the valve housing by moving the tool holder to the appropriate position.

Preferably, the tool holder is rotatable to the plurality of operative positions.

In one embodiment, the tool holder is mounted in a tool holder housing. Preferably, the tool holder is sealingly mounted in the tool holder housing.

In one embodiment the base member comprises a tubular extension forming the aperture for passage of a tool, the sealing means being located on the free end of the tubular extension.

Preferably, the apparatus further comprises a plurality of stabilizing legs. The stabilizing legs are preferably adjustable.

The apparatus may further comprise means for securing the apparatus to the valve housing.

By way of example only, specific embodiments of the present invention will be now be described, with reference to the accompanying drawings, in which:

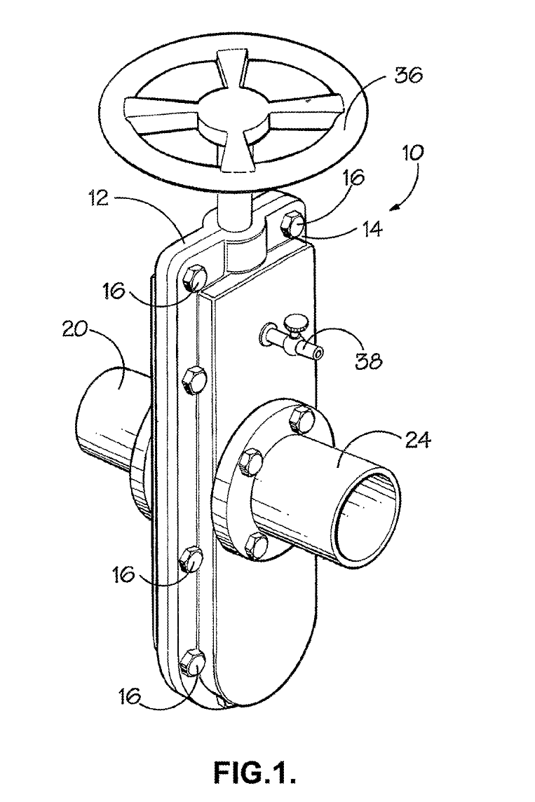

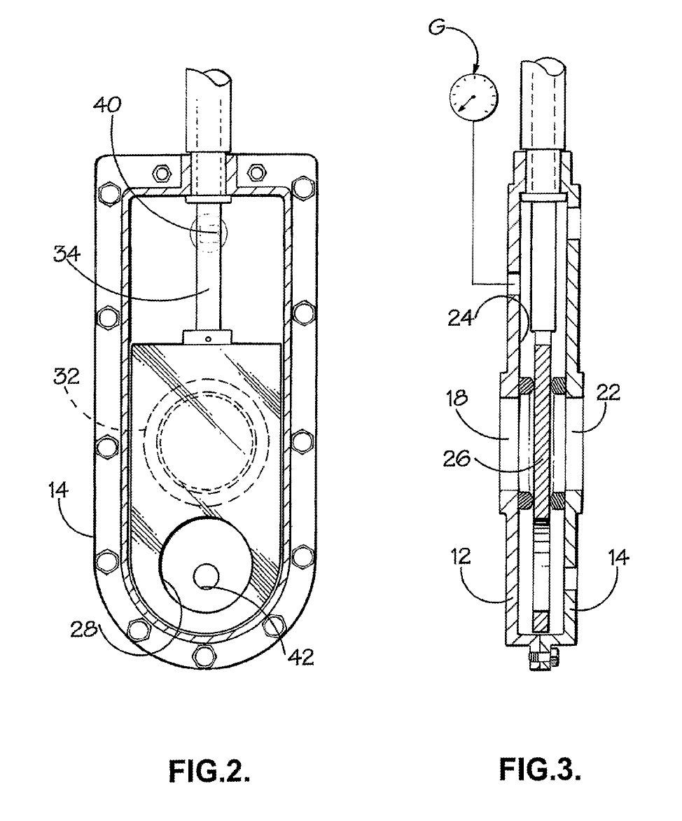

Referring firstly to FIGS. 1 to 3, a conventional gate valve 10 comprises two generally rectangular valve housing components 12, 14 which, in use, are secured together by means of bolts 16 around their periphery to form a valve housing. One housing member 12 is provided with an inlet aperture 18 for connection to a fluid inlet pipe 20 and the other housing 14 is provided with an outlet aperture 22 for connection to a fluid outlet pipe 24. The housing members 12, 14, when assembled, also define an internal recess 24 within which a valve closure plate 26 is slidably disposed. The valve closure plate 26 is provided with an aperture 28 of approximately the same size as the valve inlet and outlet apertures 18, 22 and the plate slides sealingly past two elastomeric annular seals 20, 32, arranged within the valve around the inlet and outlet apertures 18, 22 respectively. The plate is rotatably connected to a threaded valve spindle 34 which extends sealingly out of the valve housing and is connected rigidly to a hand wheel 36. By rotation of the hand wheel 36 and spindle 34 the valve closure plate can be moved between a first, open position in which the aperture 28 in the plate is aligned with the inlet and outlet apertures 18, 22 of the housing and a second, closed position in which the valve closure plate 26 is moved downwardly such that its aperture 28 is moved out of alignment with the inlet and outlet apertures 18, 22 of the housing.

The valve as described is conventional and, in the conventional manner, during assembly a thick sealant/lubricant may be placed in the interior of the valve within the recess 24 such that it is located between the moving and static parts of the valve. This both increases the sealing properties of the valve and lubricates the moving parts of the valve such that the valve can be operated when desired.

In order to replace the sealant/lubricant within the valve, either after it has hardened or, more preferably, as part of a planned maintenance procedure before it has become hardened, the following technique is used.

As illustrated in FIG. 1, gate valves of this type are normally provided with a valve 38 connected to one of the valve housing members 14. This provides an injection port, as will be explained.

If such a valve is not provided then an inlet aperture 40 is drilled in one of the valve housing members and a fluid injection plug threadedly mounted in the tapped bore.

An outlet bore 42 is also drilled and tapped at a point on the housing remote from the injection port and is provided with a closeable valve 44. A third, pressure monitoring port 46 is also drilled and tapped and provided with a closeable valve 48. The pressure monitoring port is located at a position where the pressure build up during the injection process is likely to be greatest. This will vary with the type of valve but in the present case the pressure monitoring port is provided on the opposite valve housing member to that where the inlet and outlet ports are provided, and between the inlet and outlet ports.

All three ports are drilled, tapped and provided with a valve using the apparatus to be described later.

The injection valve is connected to the outlet of a fluid injection pump (not shown). The pressure monitoring port is connected to a pressure gauge G. The outlet valve is connected to a hose (not shown) for directing material from the valve into a suitable waste receptacle.

Each of the inlet valve, outlet valve and pressure monitoring valves is opened and, if required, a solvent is firstly injected into the valve for dissolving the existing sealant if it were originally present and flushing it away through the outlet valve. Throughout the injection process the pressure within the valve is monitored by means of the pressure gauge G connected to the pressure monitoring port to ensure that the internal pressure within the valve does exceed the maximum allowed for the valve, in order to prevent damage to the valve seals 30, 32. Once the first stage of injection has been completed the inlet and outlet valves are closed off.

Once the existing sealant (if any) has been removed, if required the inlet valve is connected to the outlet of a pump for injecting new sealant under pressure. The inlet and outlet valves are opened and the sealant is injected by operation of the pump. Throughout the injection process, the pressure within the valve is continuously monitored by means of the pressure gauge G connected to the pressure monitoring port, to ensure that the pressure within the valve does not exceed the maximum pressure allowed for the valve.

When it is observed that newly introduced sealant is emerging from the outlet port of the valve, it can be assumed that the internal cavities within the valve are full of new sealant. The inlet and outlet valves are then closed, the pump is switched off and the valves can either by left in place or can be replaced with blanking plugs.

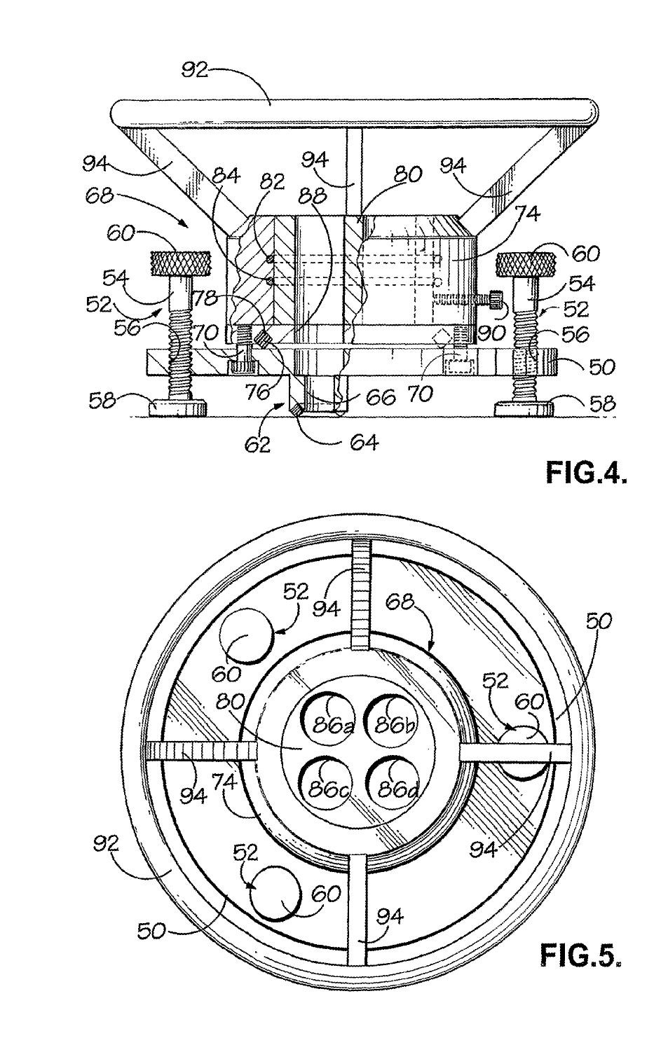

An embodiment of apparatus in accordance with the present invention for forming the necessary tapped bores is shown in FIGS. 4 to 6.

The apparatus comprises a planar main base plate 50 which carries three stabilising legs 52, each of which comprises a threaded shank 54 received in a tapped bore 56 in the base plate, a valve-engaging foot 58 at one end and a thumb wheel 60 at the opposite end. The feet may, if desired by spring-loaded in an outward direction. A tubular lug 62 projects perpendicularly from the lower face of the base plate 50 and is provided with a resiliently deformable annular seal 64 at its free end, for engagement with the outer surface of a an item (e.g. a valve or pipeline) in which the bores are to be formed. The bore of the tubular projection 62 is aligned with a through bore 66 in the main base plate.

A tubular tool housing 68 is secured above the upper surface of the main base plate 50 by means of bolts 70 passing from the undersurface of the main base plate 50, through the base plate and into the tool housing. The housing 68 comprises a housing base plate 72 and a tubular housing 74 located on the housing base plate 72. The housing base plate 72 is sealingly engaged with the main base plate 50 by means of an annular deformable seal 76 received in an annular recess 78 in the undersurface of the housing base plate 72. Alternatively, the housing base plate 72 could be welded directly to the main base plate 50, which would remove the requirement for the seal 76.

A cylindrical tool receiving body 80 is rotatably mounted within the spindle housing 68 and the two are sealed with respect to one another by means of two annular O-ring seals 82, 84 received in corresponding recesses in the cylindrical recess of the tool housing 68. The tool receiving body 80 is provided with four through bores 86a, 86b, 86c, 86d which can be aligned in turn with a corresponding bore 88 in the housing base plate 72 which in turn is aligned with the bore 66 and the tubular projection 62 of the main base plate 10. A spring-loaded locking plunger 90 mounted on the housing and engageable with one of four equally-spaced recesses in the periphery of the tool-receiving body 80 enables the tool-receiving body 80 to be indexed to align each of the bores 86a to 86d in turn with the bore 88 in the housing base plate 72. The housing 68 is also provided with a securing ring 92 which is secured to the housing by means of four arms 94.

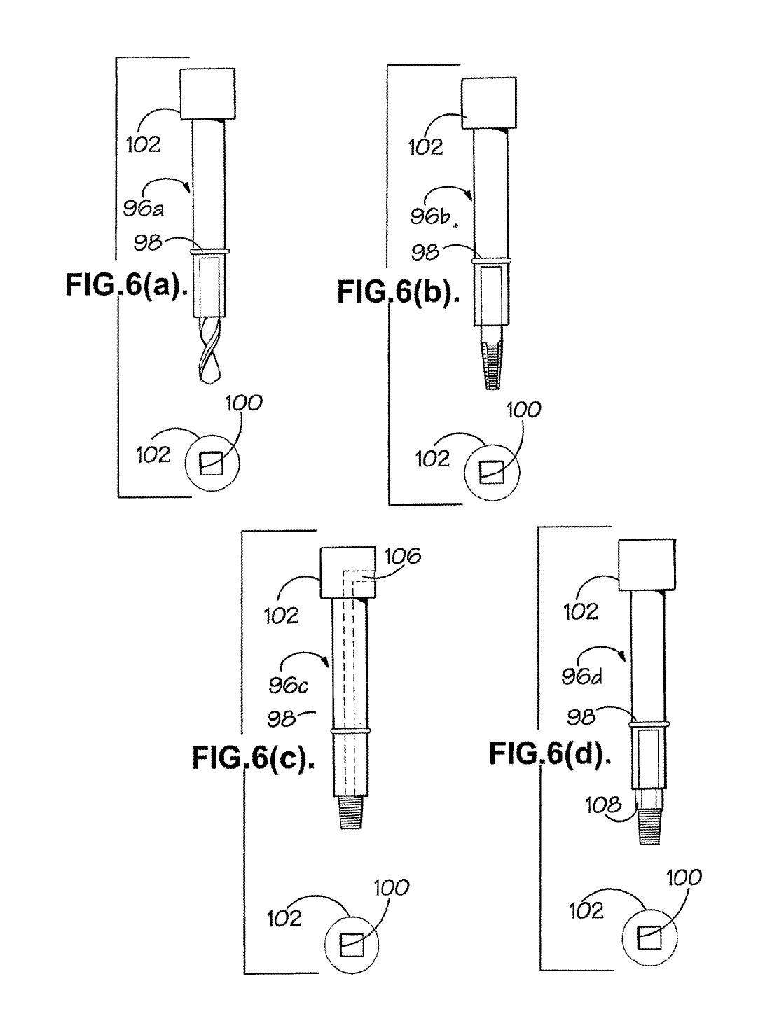

Four tools 96a, 96b, 96c, 96d are each slidably received in a respective one of the four apertures 86a to 86d of the tool-receiving body 80, namely a drilling spindle 96a (FIG. 6a), a tapping spindle 96b (FIG. 6b), an injection nozzle 96c (FIG. 6c) and a plug installation tool 96d (FIG. 6d). Each tool 96 carries an O-ring seal 98 which engages sealingly with the inner wall of its associated aperture 86. The tools are each slidable longitudinally in their respective bores and are rotatable by means of a square-sectioned recess 100 in an enlarged head portion 102. In addition tool 96c is provided with a through passage 104 leading to an inlet port 106 for injection of fluid.

In use, a threaded blanking plug 106 is secured magnetically to the lower end of the tool 96d which is then withdrawn so that the plug 106 is within the tool receiving body 80. The apparatus is then offered up to a valve (or other article) to be treated and the resiliently deformable seal 64 on the projecting tubular lug 62 is engaged with the outer surface of the valve body. The stabilising legs 52 are then adjusted to ensure that the seal 64 is firmly in contact with the valve and to ensure that the tubular lug 62 extends substantially perpendicularly to the portion of the valve which it abuts. The apparatus is then secured to the valve by attaching straps to the attachment ring 92 and fastening the straps around the valve body and/or the associated pipe work.

By rotating the tool-receiving body 80 to the appropriate position the drilling spindle 96a is firstly aligned with the aperture 88 in the base of the housing. The spindle is displaced longitudinally into contact with the outer face of the valve and is rotated to form a hole in the face of the valve.

When the appropriate bore has been formed, the drilling spindle 96a is withdrawn to a position where the drill bit lies within the tool-receiving body 80. Even in this position, however, the seal between the spindle 96a and its associated bore 86a is maintained by means of the O-ring seal 98 located on the spindle.

The tool-receiving body 80 is then indexed through 90° to the next position to align the tapping spindle 96b with the aperture 88. The spindle 96 is then displaced longitudinally to position the tapping bit in the drilled hole. The spindle 96b is then rotated, which results in tapping of the drilled bore.

The tapping spindle is then withdrawn back within the tool-receiving body 80 and the tool-receiving body 80 is then indexed through a further 90° to align the injection spindle 96c with the aperture. The injection spindle 96c is displaced longitudinally and is screwed into the tapped bore and allows fluid to be injected through the port 106 via the bore 104 into the valve.

After injection of fluid has taken place, the injection spindle 96c is withdrawn back within the tool-receiving body 80 and the tool-receiving body 80 is indexed once more through 90° to align the plug installation spindle 96d with the aperture 88 in the housing. This allows the plug 108 held by the plug installation spindle 96d to be screwed into the tapped hole, to plug the hole until it is required again.

This procedure is adopted for each aperture to be formed in the valve.

The invention is not restricted to the details of the foregoing embodiment. For example, the invention is applicable to all types of valve, not just valves of the type described and indeed to other items of equipment through which gases and liquids flow, e.g. a pipeline. Moreover, the apparatus described need not be used to carry out the method described but could be used in other methods instead.

The apparatus may differ from that described. For example, there may be fewer than, or more than, four tools as required. Moreover, there may be more than three stabilising legs 52, to simplify use on uneven or irregularly-shaped bodies.

Having fully described at least one embodiment of the present invention, other equivalent or alternative methods for the sealing of valves according to the present invention will be apparent to those skilled in the art. The invention has been described above by way of illustration, and the specific embodiments disclosed are not intended to limit the invention to the particular forms disclosed. The invention is thus to cover all modifications, equivalents, and alternatives falling within the spirit and scope of the following claims.

Claim elements and steps herein have been numbered and/or lettered solely as an aid in readability and understanding. As such, the numbering and lettering in itself is not intended to and should not be taken to indicate the ordering of elements and/or steps in the claims.

1. A method of injecting fluid into a valve, comprising the steps of:
(a) introducing the fluid into the valve under pressure through a first, inlet port in the valve housing;
(b) providing a second, outlet port in the valve housing for e/gress of material displaced from the interior of the valve; and
(c) monitoring the pressure of the fluid introduced into the valve through a third monitoring port in the valve housing.

2. The method as claimed in claim 1, comprising forming one or more of the ports in the valve housing.

3. The method as claimed in claim 1 or claim 2, wherein the monitoring port is located between the inlet port and the outlet port.

4. The method as claimed in any claims 1 to 3, wherein the fluid introduced into the valve comprises a sealant.

5. The method as claimed in any of claims 1 to 4, wherein the fluid introduced into the valve comprises a lubricant.

6. The method as claimed in any of claims 1 to 3, wherein the fluid introduced into the valve comprises a solvent.

7. The method as claimed in any of claims 1 to 3 or 6, wherein the fluid introduced into the valve comprises a flushing fluid.

8. A method of treating a valve, comprising the steps of:
(a) introducing a sealant into the valve under pressure through a first, inlet port in the valve housing;
(b) providing a second, outlet port in the valve housing for egress of material displaced from the interior of the valve;
(c) introducing a sealant/lubricant into the valve under pressure through the first, inlet port in the valve housing; and
(d) monitoring the pressure of the fluids introduced into the valve through a third, monitoring port in the valve housing.

9. An apparatus for forming an aperture in a valve housing, comprising a base member having sealing means for sealingly engaging and enclosing a portion of the surface of the valve housing, an aperture in the base member for passage of a tool into contact with a portion of the base member enclosed by the sealing means and a tall holder having a plurality of tool-receiving apertures, the tool holder being movable relative to the base member to a plurality of operative positions in each of which one of the tool-receiving apertures is aligned with the aperture in the base member.

10. The apparatus as claimed in claim 9, wherein the tool holder is rotatable to the plurality of operative positions.

11. The apparatus as claimed in claim 9 or claim 10, wherein the tool holder is mounted in a tool holder housing.

12. The apparatus as claimed in claim 11, wherein the tool holder is sealingly mounted in the tool holder housing.

13. The apparatus as claimed in claim 11 or claim 12, wherein the base member comprises a tubular extension forming the aperture for passage of a tool and wherein the sealing means is located on the free end of the tubular extension.

14. The apparatus as claimed in any of claims 9 to 13, comprising a plurality of stabilizing legs.

15. The apparatus as claimed in claim 14, wherein the stabilizing legs are adjustable.

16. The apparatus as claimed in any of claims 9 to 15, further comprising means for securing the apparatus to the valve housing.

17. A method of injecting fluid into a valve, comprising:
(a) Steps for introducing the fluid into the valve;
(b) Steps for providing egress of material displaced from the interior of the valve; and
(c) Steps for monitoring the pressure of the fluid introduced into the valve.

18. An apparatus for forming an aperture in the valve housing substantially as herein described with reference to, and as illustrated in, FIGS. 4 to 6 of the accompanying drawings.

19. An apparatus for forming an aperture in a valve housing, comprising:
means for sealingly engaging and enclosing a portion of the surface of the valve housing;
means for passage of a tool into contact with a portion of the base member enclosed by the sealing means; and
a tall holder having a plurality of tool-receiving apertures, the tool holder being movable relative to a base member to a plurality of operative positions in each of which one of the tool-receiving apertures is aligned with the aperture in the base member.
